(19) United States
(12) Patent Application Publication
(10) Pub. No.: US 2005/0255749 A1
(43) Pub. Date: Nov. 17, 2005

(54) Subassembly for a female inline contact

(76) Inventor: Michael J. Swantner, Warren, PA (US)

Correspondence Address: William H. McNeill;OSRAM SYLVANIA Inc., 100 Endicott Street, Danvers, MA, 01923, US

(21) Appl. No.: 10/929,700

(22) Filed: Aug. 30, 2004

Related U.S. Application Data
(60) Provisional application No. 60/571,211, filed on May 14, 2004.

(51) Int. Cl. H01R 33/02

(52) U.S. Cl. 439/595

(57) ABSTRACT

A subassembly (10) for an inline female contact has an electrically conductive member (12) and a tubular insulating member (14) surrounding said electrically conductive member (12). The electrically conductive member (12) comprises a male receiving end (16), a wire receiving end (18) and an intermediate portion (20) connecting the male receiving end (16) and the wire receiving end (18). An expansion slot (22) extends longitudinally at least the length of the male receiving end (16) and the intermediate portion (20). The male receiving end (16) is substantially tubular with an outwardly flared terminus (24). To aid in the insertion process the tubular male receiving end (16) can be slightly tapered from the intermediate portion (20) to the flared terminus (24). A first camming surface (26) is formed on a leading area (27) of the intermediate portion (20), and a second, cooperating camming surface (28) is formed on a trailing area (29) of a cantilever arm (30) formed in the insulating member (14). A first retention section (32) is formed on the cantilever beam (30) for cooperating with a second retention section (34) formed on the intermediate portion (20).

This application claims priority from Provisional Patent Application No. 60/571,211, filed May 14, 2004.

### TECHNICAL FIELD

This invention relates to electrical connectors and more particularly to terminal connectors for coaxial cable.

### BACKGROUND ART

A previous connector, shown in U.S. patent application Ser. No. 10/783,443, filed Feb. 20, 2004 and assigned to the assignee of the present invention, employs a first electrical contact with a first end affixed to a first section of exposed central conductor of a coaxial cable and has a hollow second end formed to engage a mating electrical contact. The second end is provided with a plurality of cantilevered beams to flexibly grasp a male contact.

The first electrical contact is inserted into an electrically insulating member provided with a longitudinal opening. The insertion process often damaged the cantilevered beams of the male electrical contact and this damage often remained hidden until an attempt was made to mate the connector.

### DISCLOSURE OF INVENTION

It is, therefore, an object of the invention to obviate the disadvantages of the prior art.

It is another object of the invention to enhance coaxial cable connectors.

Another object of the invention is the avoidance of damaged contacts.

These objects are accomplished in one aspect of the invention, by the provision of a subassembly for an inline female contact comprising: an electrically conductive member and a tubular insulating member surrounding the electrically conductive member, the electrically conductive member comprising a male receiving end, a wire receiving end and an intermediate portion connecting the male receiving end and the wire receiving end; an expansion slot extending longitudinally at least the length of the male receiving end and the intermediate portion, the male receiving end being substantially tubular with an outwardly flared terminus; a first camming surface formed on a leading area of the intermediate portion; a second camming surface formed on a trailing area of a cantilever arm formed in the insulating member; and a first retention section formed on the cantilever arm for cooperating with a second retention section formed on the intermediate portion.

The replacement of the cantilevered beams with the tubular end having an outwardly flared terminus eliminates the chance of end distortion and enhances the installation process. Further, the provision of mutually acting camming surfaces formed on the intermediate portion and the flexible cantilevered arms of the insulating member also contributes to enhanced insertion and good retention.

### BRIEF DESCRIPTION OF THE DRAWINGS

FIG. 1 is an elevational sectional view of an electrically conductive member in accordance with and aspect of the invention; and

FIG. 2 is an elevational sectional view of the mated electrically conductive member and an insulating member.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

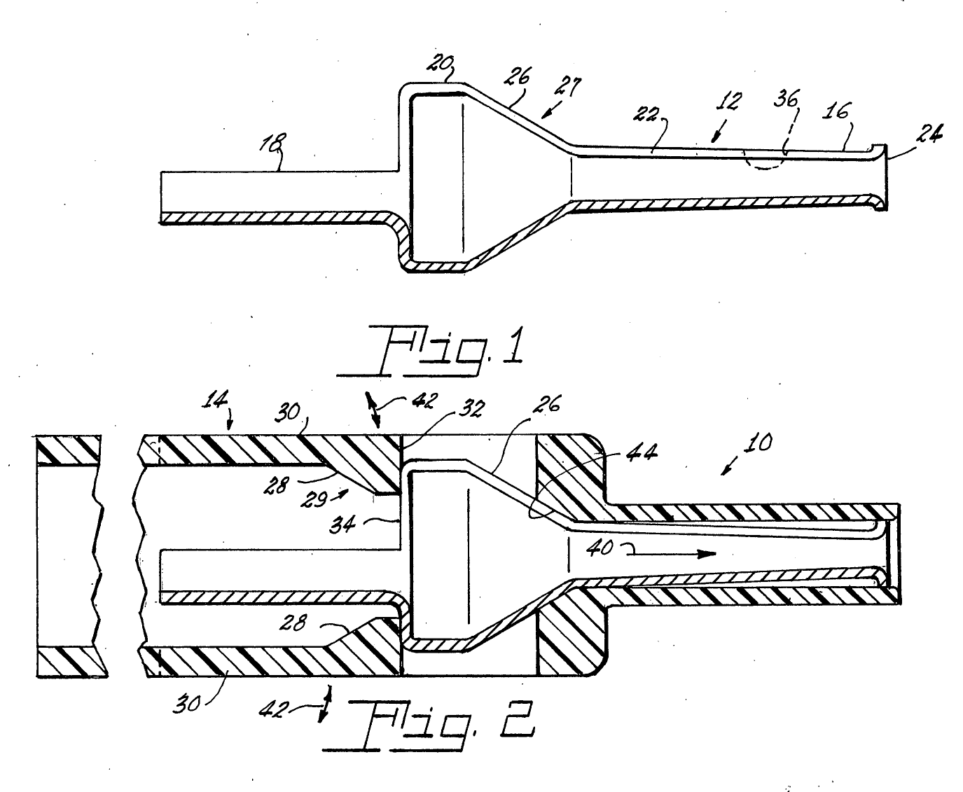

Referring now to the drawings with greater particularity, there is shown in FIG. 2 a subassembly 10 for an inline female contact comprising an electrically conductive member 12 and a tubular insulating member 14 surrounding said electrically conductive member 12. The electrically conductive member 12 (see FIG. 1) comprises a male receiving end 16, a wire receiving end 18 and an intermediate portion 20 connecting the male receiving end and the wire receiving end. In the embodiment shown the wire receiving end 18 is pictured as a trough; however, other configurations are of course useable. An expansion slot 22 extends longitudinally at least the length of the male receiving end 16 and the intermediate portion 20. The male receiving end 16 is substantially tubular with an outwardly flared terminus 24. To aid in the insertion process the tubular male receiving end 16 can be slightly tapered from the intermediate portion 20 to the flared terminus 24.

A first camming surface 26 is formed on a leading area 27 of the intermediate portion 20, and a second, cooperating camming surface 28 is formed on a trailing area 29 of a cantilever arm 30 formed in the insulating member 14.

A first retention section 32 is formed on the cantilever beam 30 for cooperating with a second retention section 34 formed on the intermediate portion 20.

In a preferred embodiment of the invention the insulating member 14 contains two cantilever arms 30 oppositely disposed from one another.

Further, the male receiving end 16 can have a transverse groove 36 formed substantially centered between its ends. The groove 36 can be used to adjust the normal force if such adjustment is necessary.

To form the inline connector 10 the electrically conductive member 12 is inserted into the insulating member 14 in the direction of arrow 40. As the insertion continues the first camming surface 26 encounters the second camming surface 28, forcing the cantilevered arms 30 outwardly in the direction of arrows 42. The insertion continues until the first camming surface 26 engages a stop wall 44, at which point the cantilevered arms 30 resize to their original position, bringing the first retention section 32 into contact with the second retention section 34, thereby locking the electrically conductive member 12 into position.

The insertion of the electrically conductive member 12 into the tubular insulating member 14 completes the subassembly 10, which can then, in turn, be inserted into a an electrically conductive metal shell, as know to those skilled in the art.

There is thus provided a subassembly for an inline female connector that has an electrically conductive member that has reduced chances for damage during insertion and that is firmly, and automatically locked into position when the insertion is completed.

While there have been shown and described what are present considered to be the preferred embodiments of the invention, it will be apparent to those skilled in the art that various changes and modifications can be made herein without departing from the scope of the invention as defined by the appended claims.

1. An subassembly for inline female contact comprising:
an electrically conductive member and a tubular insulating member surrounding said electrically conductive member, said electrically conductive member comprising a male receiving end, a wire receiving end and an intermediate portion connecting said male receiving end and said wire receiving end; an expansion slot extending longitudinally at least the length of said male member receiving end and said intermediate portion, said male receiving end being substantially tubular with an outwardly flared terminus;
a first camming surface formed on a leading area of said intermediate portion;
a second camming surface formed on a trailing area of a cantilever beam formed in said insulating member; and
a first retention section formed on said cantilever beam for cooperating with a second retention section formed on said intermediate portion.

2. The subassembly of claim 1 wherein said insulating member contains two cantilever beams oppositely disposed from one another.

3. The subassembly of claim 1 wherein said male receiving end has a transverse groove substantially centered between its ends.
